(19) United States
(12) Patent Application Publication
(10) Pub. No.: US 2014/0258904 A1
(43) Pub. Date: Sep. 11, 2014

(54) TERMINAL AND METHOD OF CONTROLLING THE SAME

(71) Applicant: Samsung Display Co., Ltd., Yongin-city (KR)

(72) Inventor: Ja Seung Ku, Yongin-city (KR)

(73) Assignee: Samsung Display Co., Ltd., Yongin-city (KR)

(21) Appl. No.: 14/036,473

(22) Filed: Sep. 25, 2013

(30) Foreign Application Priority Data
Mar. 8, 2013 (KR) 10-2013-0025172

(51) Int. Cl. G06F 3/0484; G06F 3/0486; G06F 3/0485

(52) U.S. Cl. CPC G06F 3/04845; G06F 3/0485; G06F 3/0486
USPC 715/769

(57) ABSTRACT

A terminal and a method of controlling the same are disclosed. In one aspect, the terminal includes an input device configured to receive information from an external source, a display configured to display an image, and a controller configured to control the image displayed on the display according to the received information, wherein the input device comprises a touchscreen. The controller detects the number of touched points on the touchscreen, the magnitude of the pressure applied to each touched point and the position of each touched point based on the information received by the input unit and controls the image displayed on the display to be enlarged, reduced or scrolled based on the number, the magnitude and the position.

This application claims priority from Korean Patent Application No. 10-2013-0025172 filed on Mar. 8, 2013 in the Korean Intellectual Property Office, the disclosure of which is incorporated herein by reference in its entirety.

### BACKGROUND

1. Field

The described technology generally relates to a terminal and a method of controlling the same.

2. Description of the Related Technology

The development of information and communications technology and various needs of the information society are resulting in fast popularization of terminals such as personal computers, smartphones, mobile terminals and portable electronic devices. A user can input data to a terminal by using various input devices such as a keyboard, a mouse, a trackball, a stylus pen, a touch screen, buttons, etc.

A graphical user interface (GUI) is an environment in which a user can exchange information with an electronic device through the graphical screen. As electronic devices develop, various types of terminals that need to be controlled by a user are employing the GUI so as to exchange information with the user through the GUI.

In the GUI environment, an icon corresponding to a certain function may be displayed on a display unit of a terminal, and a user may activate the function by clicking on or selecting the icon using an input unit of the terminal. For example, the user may enlarge or reduce a certain portion of a screen displayed on the display unit of the terminal by clicking on or selecting an icon. In addition, the user may scroll the screen displayed on the display unit of the terminal by clicking on or selecting another icon.

### SUMMARY

One inventive aspect is a terminal which can more easily enlarge, reduce or scroll a displayed screen (or image) and a method of controlling the terminal.

Another aspect is a terminal which can enlarge, reduce or scroll a screen without selection of an icon or menu and a method of controlling the terminal.

Another aspect is a terminal which can more rapidly enlarge, reduce or scroll a screen and a method of controlling the terminal.

Another aspect is a terminal comprising an input unit which receives information from an external source, a display unit which displays a screen (or image), and a control unit which controls the screen displayed on the display unit according to the information received by the input unit, wherein the input unit comprises a touchscreen, and the control unit detects the number of touched points on the touchscreen, the magnitude of the pressure applied to each touched point and the position of each touched point based on the information received by the input unit and controls the screen displayed on the display unit to be enlarged, reduced or scrolled based on the number of touched points, the magnitude of the pressure applied to each touched point and the position of each touched point.

When the number of touched points is one, the control unit may control the screen to be enlarged or reduced based on the position of the touched point, and when the position of the touched point is changed by dragging the touched point, the control unit may control the screen to be enlarged or reduced based on the changed position of the touched point.

When the number of touched points is one, the control unit may control the screen to be enlarged or reduced according to the magnitude of the pressure applied to the touched point.

The control unit may control the screen to be enlarged to a larger size as the magnitude of the pressure applied to the touched point increases or control the screen to be reduced to a smaller size as the magnitude of the pressure increases.

The control unit may control the screen to be enlarged to a larger size as the magnitude of the pressure applied to the touched point decreases or control the screen to be reduced to a smaller size as the magnitude of the pressure decreases.

When the number of touched points is two, the control unit may control the screen to be enlarged or reduced to a magnification corresponding to the magnitude of the pressure applied to a first point, which was touched first, at a moment when a second point was touched and control the magnification to be maintained despite a change in the magnitude of the pressure applied to the first point or a change in the magnitude of the pressure applied to the second point after the second point was touched.

When the position of the first point or the position of the second point is changed by dragging the first point or the second point, the control unit may control the screen to be scrolled according to the changed position of the first point or the changed position of the second point.

The control unit may control the screen to be scrolled according to a change in the position of the first point, regardless of a change in the position of the second point.

Coordinates of the first point before being dragged may be (x1, y1), coordinates of the second point before being dragged may be (x2, y2), the coordinates of the first point after being dragged may be (x1′, y1′), the coordinates of the second point after being dragged may be (x2′, y2′), and the control unit may control the screen to be scrolled by (x1′−x1, y1′−y1).

The control unit may control the screen to be scrolled in a state where the screen has been enlarged or reduced to the magnification corresponding to the magnitude of the pressure applied to the first point at the moment when the second point was touched.

When the position of the first point or the position of the second point is changed by dragging the first point or the second point, the control unit may control the screen to be scrolled according to a change in the position of a midpoint between the first point and the second point.

The coordinates of the first point before being dragged may be (x1, y1), the coordinates of the second point before being dragged may be (x2, y2), the coordinates of the first point after being dragged may be (x1′, y1′), the coordinates of the second point after being dragged may be (x2′, y2′), and the control unit may control the screen to be scrolled by ((x1′+x2′)/2−(x1+x2)/2, (y1′+y2′)/2−(y1+y2)/2).

Another aspect is a method of controlling a terminal having a touchscreen, the method comprising receiving a touch input on a first point on the touchscreen, displaying, on the touchscreen, a screen which has been enlarged to a magnification corresponding to the pressure applied to the first point, receiving a touch input on a second point on the touchscreen, displaying, on the touchscreen, the screen which has been enlarged to a certain magnification regardless of a change in the pressure applied to the first point and a change in the pressure applied to the second point after the touch input on the second point was received, receiving an input corresponding to dragging the first point or the second point, and scrolling the enlarged screen according to a change in the position of the first point, regardless of a change in the position of the second point, and displaying the scrolled screen on the touchscreen.

The displaying, on the touchscreen, of the screen which has been enlarged to the magnification corresponding to the pressure applied to the first point may comprise displaying the screen enlarged to a higher magnification on the touchscreen as the magnitude of the pressure applied to the first point increases.

The displaying, on the touchscreen, of the screen which has been enlarged to the magnification corresponding to the pressure applied to the first point may comprise changing the magnification of the enlarged screen when the pressure applied to the first point is changed.

The displaying, on the touchscreen, of the screen which has been enlarged to the certain magnification may comprise maintaining the magnification of the screen at a magnification corresponding to the magnitude of the pressure applied to the first point at a moment when the second point was touched despite a change in the pressure applied to the first point or a change in the pressure applied to the second point after the touch input on the second point was received.

The scrolling of the enlarged screen and the displaying of the scrolled screen on the touchscreen may comprise controlling the screen to be scrolled in a direction in which the first point was moved by the distance travelled by the first point.

Another aspect is a method of controlling a terminal having a touchscreen, the method comprising receiving a touch input on a first point on the touchscreen, displaying, on the touchscreen, a screen which has been reduced to a magnification corresponding to the pressure applied to the first point, receiving a touch input on a second point on the touchscreen, displaying, on the touchscreen, the screen which has been reduced to a certain magnification regardless of a change in the pressure applied to the first point and a change in the pressure applied to the second point after the touch input on the second point was received, receiving an input corresponding to dragging the first point or the second point, and scrolling the reduced screen according to a change in the position of the first point, regardless of a change in the position of the second point, and displaying the scrolled screen on the touchscreen.

Another aspect is a method of controlling a terminal having a touchscreen, the method comprising receiving a touch input on a first point on the touchscreen, displaying, on the touchscreen, a screen which has been enlarged or reduced to a magnification corresponding to the pressure applied to the first point, receiving a touch input on a second point on the touchscreen, displaying, on the touchscreen, the screen which has been enlarged or reduced to a certain magnification regardless of a change in the pressure applied to the first point and a change in the pressure applied to the second point after the touch input on the second point was received, receiving an input corresponding to dragging the first point or the second point, and scrolling the enlarged or reduced screen according to a change in the position of a midpoint between the first point and the second point and displaying the scrolled screen on the touchscreen.

The scrolling of the enlarged or reduced screen and the displaying of the scrolled screen on the touchscreen may comprise controlling the screen to be scrolled in a direction in which the midpoint between the first point and the second point was moved by the distance travelled by the midpoint.

### BRIEF DESCRIPTION OF THE DRAWINGS

FIG. 1 is a block diagram illustrating the configuration of a terminal according to an embodiment.

FIG. 2 is a graph illustrating the operation of a control unit of the terminal according to a first embodiment.

FIG. 3 is a graph illustrating the operation of the control unit of the terminal according to the first embodiment.

FIG. 4 is a graph illustrating the operation of the control unit of the terminal according to the first embodiment.

FIG. 5 is a plan view of the terminal, illustrating paths along which touched points are dragged according to the first embodiment.

FIG. 6 is a graph illustrating the operation of the control unit of the terminal according to a second embodiment.

FIG. 7 is a plan view of the terminal, illustrating paths along which touched points are dragged according to a third embodiment.

FIG. 8 is a flowchart illustrating a method of controlling a terminal according to a first embodiment.

FIG. 9 is a flowchart illustrating a method of controlling a terminal according to a second embodiment.

FIG. 10 is a flowchart illustrating a method of controlling a terminal according to a third embodiment.

### DETAILED DESCRIPTION

The present invention may, however, be embodied in many different forms and should not be construed as being limited to the embodiments set forth herein. Like numbers refer to like elements throughout. In the drawings, the thickness of layers and regions are exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views of embodiments. Accordingly, the exemplary views may be modified depending on manufacturing technologies and/or tolerances. Therefore, the embodiments are not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the invention.

Embodiments will now be described more fully with reference to the accompanying drawings.

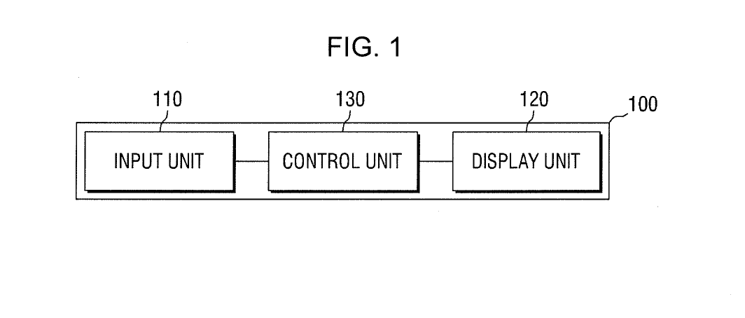

FIG. 1 is a block diagram illustrating the configuration of a terminal 100 according to an embodiment. The terminal 100 may be an electronic device that can process documents, such as a personal computer, a smartphone, a mobile terminal or a portable electronic device.

Referring to FIG. 1, the terminal 100 according to the current embodiment may include an input unit (or an input device) 110 which receives information from an external source, a display unit (or a display) 120 which displays a screen (or image), and a control unit (or a controller) 130 which controls the screen displayed on the display unit 120 according to the information received by the input unit 110.

The input unit 110 may receive information from an external source. The input unit 110 may receive information from a user of the terminal 100 or from an external device. The input unit 110 may be, for example, buttons, a touchscreen, a trackball, a stylus pen, an acceleration sensor, an optical sensor, an ultrasonic sensor, an infrared sensor, a microphone, a keyboard, a mouse, or a network interface.

The input unit 110 may include a touchscreen. The touchscreen may be a resistive touchscreen or a capacitive touchscreen. The user of the terminal 100 may touch an arbitrary point on the touchscreen with an arbitrary pressure by using a finger.

The display unit 120 may display a screen. The display unit 120 may be a flat panel display such as a liquid crystal display (LCD), an organic light-emitting diode (OLED), or a plasma display panel (PDP). The display unit 120 and the input unit 110 may be integrated with each other like a touchscreen or may be separated from each other.

The control unit 130 may control each component of the terminal 100. The control unit 130 may be, for example, a central processing unit (CPU) or a microcontroller unit (MCU).

The control unit 130 may control the screen displayed on the display unit 120 based on information received by the input unit 110. For example, it is assumed that the user of the terminal 100 touches a point on the touchscreen of the input unit 110 with a certain pressure by using a finger. Here, the user may touch one point on the touchscreen or substantially simultaneously touch two or more points on the touchscreen.

The control unit 130 may receive information about the touch from the input unit 110. The control unit 130 may detect the number of points touched, the magnitude of the pressure applied to each touched point, and the position of each touched point based on the received information.

If the touchscreen included in the input unit 110 is a resistive touchscreen, the input unit 110 may detect the magnitude of the pressure applied to a touched point, and the information about the touch may include information about the magnitude of the pressure detected by the input unit 110.

If the touchscreen included in the input unit 110 is a capacitive touchscreen, the control unit 130 may detect the size of an area of the touchscreen touched by the user's finger. The control unit 130 may detect the magnitude of the pressure applied to a touched point on the touchscreen based on the size of the area touched by the user's finger. For example, the control unit 130 may convert the size of the area touched by the user's finger into the magnitude of pressure. As the size of the area touched by the user's finger increases, the control unit 130 may convert the size of the area into a greater magnitude of pressure.

The control unit 130 may control the screen displayed on the display unit 120 to be enlarged, reduced or scrolled based on the number of points touched, the magnitude of the pressure applied to each touched point, and the position of each touched point.

In a case where the number of points touched is one, the control unit 130 may control the screen to be enlarged or reduced based on the position of the touched point.

When the position of the touched point is changed by dragging the touched point, the control unit 130 may control the screen to be enlarged or reduced based on the changed position.

In addition, the control unit 130 may control the screen to be enlarged or reduced based on the magnitude of the pressure applied to the touched point. The control unit 130 may control the screen to be enlarged to a larger size as the magnitude of the pressure increases. According to another embodiment, the control unit 130 may control the screen to be reduced to a smaller size as the magnitude of the pressure increases. According to another embodiment, the control unit 130 may control the screen to be enlarged to a larger size as the magnitude of the pressure decreases. According to another embodiment, the control unit 130 may control the screen to be reduced to a smaller size as the magnitude of the pressure decreases.

In a case where the number of points touched is two, one of the two touched points which is touched first may be referred to as a first point and the other one which is touched later may be referred as a second point. In this case, the control unit 130 may control the screen to be enlarged or reduced according to the magnitude of the pressure applied to the first point at a moment when the second point is touched. After the second point is touched, the control unit 130 may control the screen to be no longer enlarged or reduced despite a change in the magnitude of the pressure applied to the first point or the magnitude of the pressure applied to the second point.

In other words, before the second point is touched, the control unit 130 may control the magnification of the screen to be changed according to the magnitude of the pressure applied to the first point. However, after the second point is touched, the control unit 130 may control the magnification of the screen to be fixed at a magnification corresponding to the magnitude of the pressure applied to the first point at the moment when the second point was touched.

When the first point or the second point is dragged to a new position, the control unit 130 may control the screen to be scrolled according to the new position of the first point or the second point.

For example, the control unit 130 may control the screen to be scrolled according to a change in the position of the first point, regardless of a change in the position of the second point. In other words, the control unit 130 may control the screen to be scrolled according to the position of the first point, regardless of the position of the second point. The control unit 130 may control the screen to be scrolled in a direction in which the first point was moved by the distance travelled by the first point.

For example, coordinates of the first point before being dragged may be (x1, y1), and coordinates of the second point before being dragged may be (x2, y2). In addition, the coordinates of the first point after being dragged may be (x1′, y1′), and the coordinates of the second point after being dragged may be (x2′, y2′). In this case, the control unit 130 may control the screen to be scrolled by (x1′−x1, y1′−y1). Here, the control unit 130 may control the screen to be scrolled in a state where the screen has been enlarged or reduced to a magnification corresponding to the magnitude of the pressure applied to the first point when the second point was touched.

According to another embodiment, the control unit 130 may control the screen to be scrolled according to a change in a midpoint between the first point and the second point. In other words, the control unit 130 may control the screen to be scrolled according to the position of the midpoint between the first point and the second point. The control unit 130 may control the screen to be scrolled in a direction in which the midpoint between the first point and the second point was moved by the distance travelled by the midpoint.

For example, the coordinates of the first point before being dragged may be (x1, y1), and the coordinates of the second point before being dragged may be (x2, y2). In addition, the coordinates of the first point after being dragged may be (x1′, y1′), and the coordinates of the second point after being dragged may be (x2′, y2′).

Coordinates of the midpoint between the first and second points before being dragged may be ((x1+x2)/2, (y1+y2)/2)), and the coordinates of the midpoint between the first and second points after being dragged may be ((x1′+x2′)/2, (y1′+y2′)/2)). In this case, the control unit 130 may control the screen to be scrolled by ((x1′+x2′)/2−(x1+x2)/2, (y1′+y2′)/2−(y1+y2)/2). Here, the control unit 130 may control the screen to be scrolled in a state where the screen has been enlarged or reduced to a magnification corresponding to the magnitude of the pressure applied to the first point when the second point was touched.

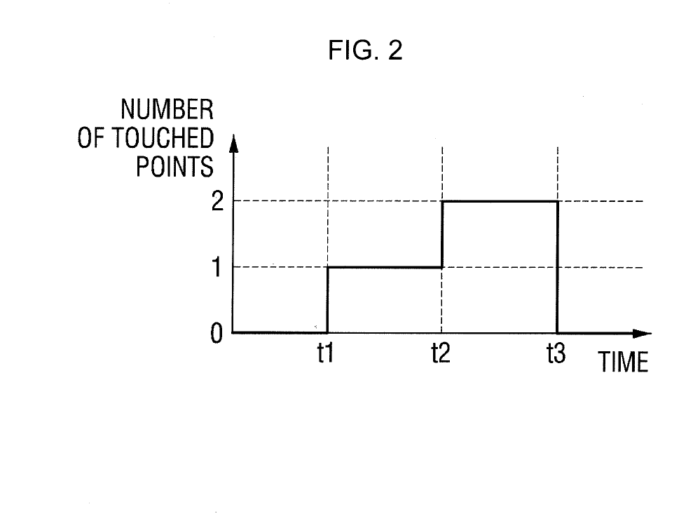

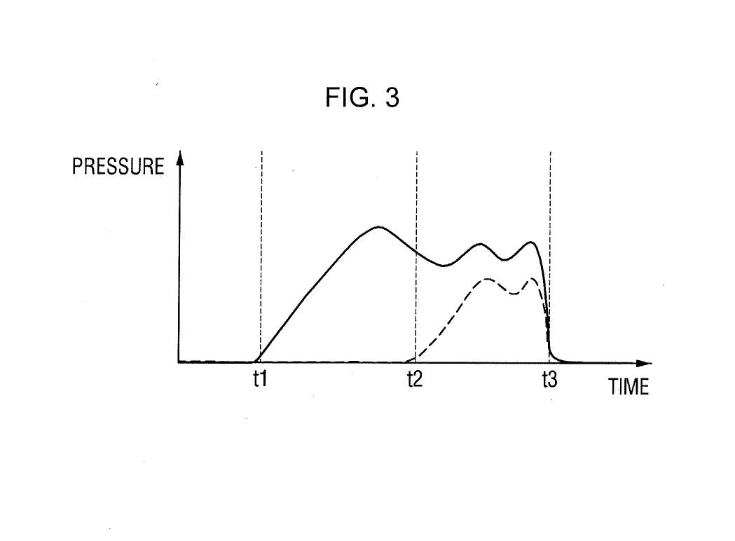

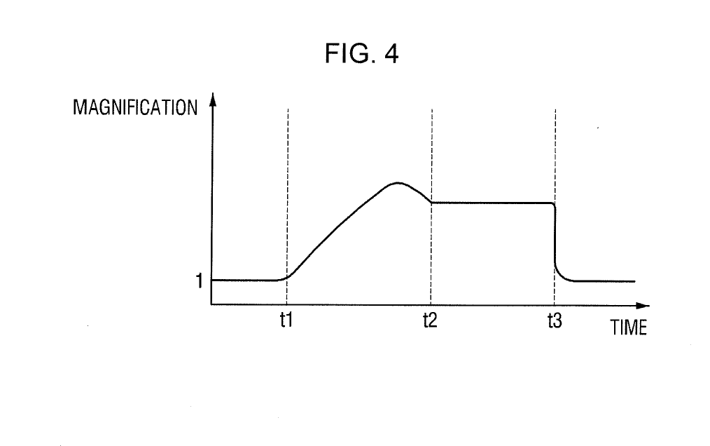

FIGS. 2 through 4 are graphs illustrating the operation of the control unit 130 of the terminal 100 according to a first embodiment. In the graph of FIG. 2, the x axis represents time, and they axis represents the number of points touched. In the graph of FIG. 3, the x axis represents time, and they axis represents the magnitude of the pressure applied to a touched point. In the graph of FIG. 4, the x axis represents time, and the y axis represents the magnification of a screen.

Referring to the graph of FIG. 2, no point may be touched in a section before t1.

In this section, a screen displayed on the display unit 120 may not be enlarged.

At t1, one point may start to be touched. In a section from t1 to t2, only one point may be touched. The touched point will be referred to as a first point.

The magnitude of the pressure applied to the first point in the section from t1 to t2 may change as shown in the graph of FIG. 3. In addition, the screen displayed on the display unit 120 in the section from t1 to t2 may be enlarged according to the magnitude of the pressure applied to the first point. As shown in the graph of FIG. 4, the screen displayed on the display unit 120 in the section from t1 to t2 may be enlarged in proportion to the magnitude of the pressure applied to the first point.

Referring back to the graph of FIG. 2, at t2, a second point may start to be touched, in addition to the first point. In a section from t2 to t3, two points may be touched.

The magnitude of the pressure applied to the first point and the magnitude of the pressure applied to the second point in the section from t2 to t3 may change as shown in the graph of FIG. 3. As shown in the graph of FIG. 4, the screen displayed in the section from t2 to t3 may be enlarged to a magnification corresponding to the magnitude of the pressure applied to the first point at t2.

In other words, the magnification of the screen displayed in the section from t2 to t3 may be maintained at the magnification of the screen at t2. Therefore, the magnification of the screen may be maintained at the magnification of the screen at t2, regardless of the magnitude of the pressure applied to the first point and the magnitude of the pressure applied to the second point during the section from t2 to t3.

In a section after t3, no point may be touched. In this section, the magnification of the screen displayed on the display unit 120 may return to its original magnification.

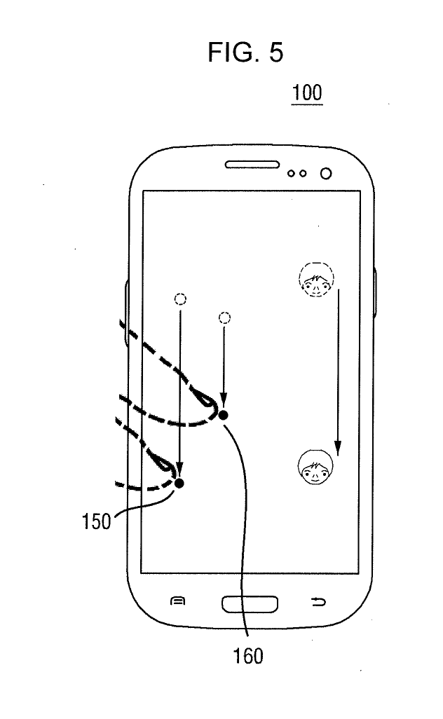

FIG. 5 is a plan view of the terminal 100, illustrating paths along which the first and second points are dragged according to the first embodiment. Referring to FIG. 5, the first point may be dragged from (x1, y1) to (x1′, y1′), and the second point may be dragged from (x2, y2) to (x2′, y2′). The control unit 130 may control the screen to be scrolled in a direction in which the first point was moved by the distance travelled by the first point, regardless of a change in the position of the second point. Therefore, the screen displayed on the display unit 120 of the terminal 100 may be moved by (x1′−x1, y1′−y1).

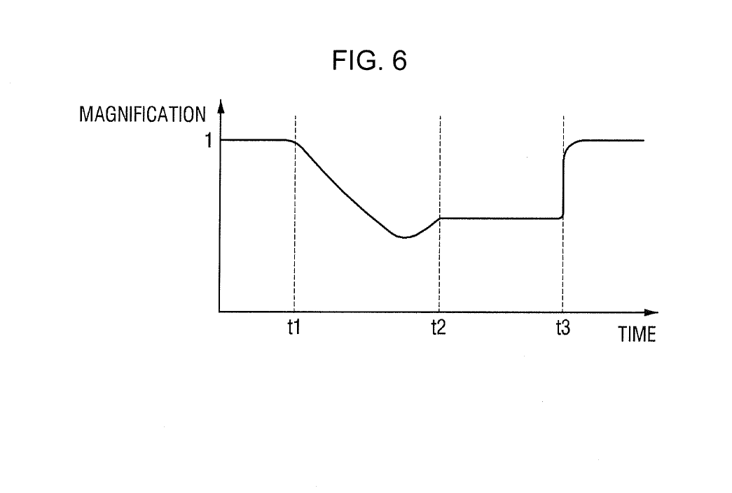

FIG. 6 is a graph illustrating the operation of the control unit 130 of the terminal 100 according to a second embodiment. In the graph of FIG. 6, the x axis represents time, and they axis represents the magnification of a screen. While FIGS. 2 and 3 were referred to in order to describe the operation of the control unit 130 of the terminal 100 according to the first embodiment, they will be referred to again in order to describe the operation of the control unit 130 of the terminal according to the second embodiment.

Referring to the graph of FIG. 2, no point may be touched in a section before t1. In this section, a screen displayed on the display unit 120 may not be reduced.

At t1, one point may start to be touched. In a section from t1 to t2, only one point may be touched. The touched point will be referred to as a first point.

The magnitude of the pressure applied to the first point in the section from t1 to t2 may change as shown in the graph of FIG. 3. In addition, the screen displayed on the display unit 120 in the section from t1 to t2 may be reduced according to the magnitude of the pressure applied to the first point. As shown in the graph of FIG. 6, the screen displayed on the display unit 120 in the section from t1 to t2 may be reduced in proportion to the magnitude of the pressure applied to the first point.

Referring back to the graph of FIG. 2, at t2, a second point may start to be touched, in addition to the first point. In a section from t2 to t3, two points may be touched.

The magnitude of the pressure applied to the first point and the magnitude of the pressure applied to the second point in the section from t2 to t3 may change as shown in the graph of FIG. 3. As shown in the graph of FIG. 6, the screen displayed in the section from t2 to t3 may be reduced to a magnification corresponding to the magnitude of the pressure applied to the first point at t2.

In other words, the magnification of the screen displayed in the section from t2 to t3 may be maintained at the magnification of the screen at t2. Therefore, the magnification of the screen may be maintained at the magnification of the screen at t2, regardless of the magnitude of the pressure applied to the first point and the magnitude of the pressure applied to the second point during the section from t2 to t3.

In a section after t3, no point may be touched. In this section, the magnification of the screen displayed on the display unit 120 may return to its original magnification.

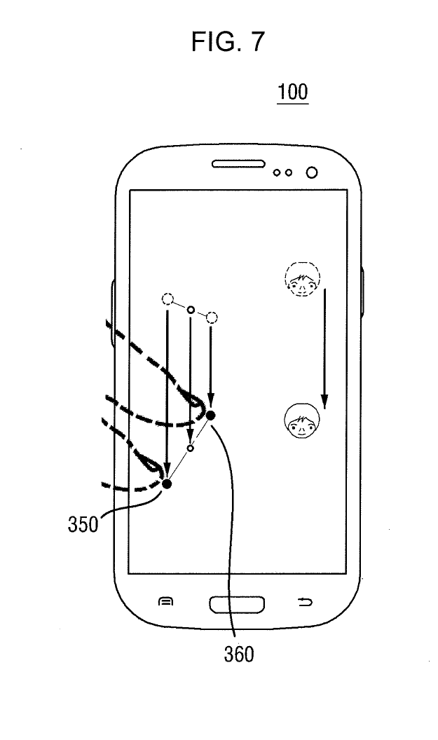

FIG. 7 is a plan view of the terminal 100, illustrating paths along which the first and second points are dragged according to a third embodiment. Referring to FIG. 7, the first point may be dragged from (x1, y1) to (x1′, y1′), and the second point may be dragged from (x2, y2) to (x2′, y2′). The control unit 130 may control the screen to be scrolled in a direction in which a midpoint between the first point and the second point was moved by the distance travelled by the midpoint. Therefore, the screen displayed on the display unit 120 of the terminal 100 may be moved by ((x1′+x2′)/2−(x1+x2)/2, (y1′+y2′)/2−(y1+y2)/2).

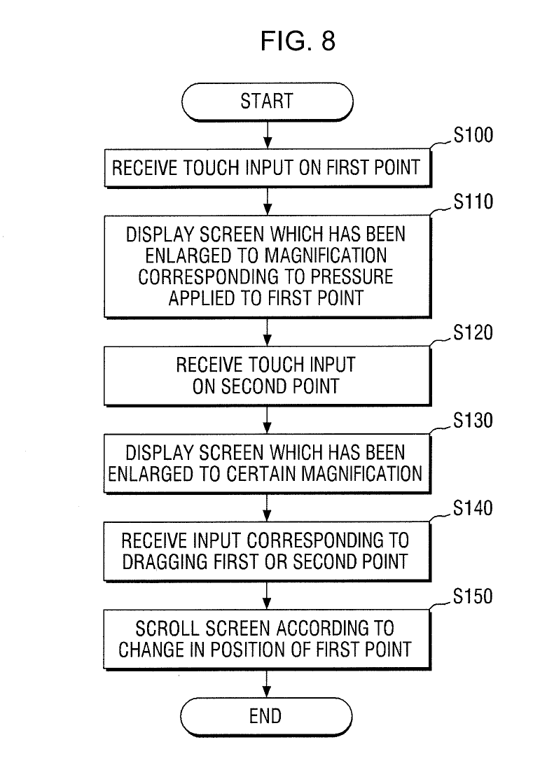

FIG. 8 is a flowchart illustrating a method of controlling the terminal 100 according to a first embodiment. Referring to FIG. 8, in the method of controlling the terminal 100 according to the first embodiment, a touch input on a first point on the touchscreen of the terminal 100 may be received (operation S100).

Then, a screen enlarged to a magnification corresponding to the pressure applied to the first point may be displayed on the touchscreen (operation S110). The control unit 130 of the terminal 100 may control the screen to be enlarged to a larger size as the magnitude of the pressure increases. Alternatively, the control unit 130 of the terminal 100 may control the screen to be enlarged to a larger size as the magnitude of the pressure decreases. When the pressure applied to the first point is changed, the magnification of the enlarged screen may also be changed.

Next, a touch input on a second point on the touchscreen may be received (operation S120).

Then, the screen enlarged to a certain magnification regardless of a change in the pressure applied to the first point and a change in the pressure applied to the second point after the touch input on the second point was received may be displayed on the touchscreen (operation S130).

The control unit 130 may control the screen to be enlarged to a magnification corresponding to the magnitude of the pressure applied to the first point when the second point started to be touched, regardless of the change in the pressure applied to the first point and the change in the pressure applied to the second point after the touch input on the second point was received. In other words, even if the pressure applied to the first point or the second point is changed after the touch input on the second point is received, the control unit 130 may control the magnification of the screen to be maintained at the magnification corresponding to the magnitude of the pressure applied to the first point when the second point started to be touched.

An input corresponding to dragging the first point or the second point may be received (operation S140).

Then, the enlarged screen may be scrolled according to a change in the position of the first point, regardless of a change in the position of the second point, and may be displayed accordingly on the touchscreen (operation S150). The control unit 130 may control the screen to be scrolled according to the position of the first point, regardless of the position of the second point. The control unit 130 may control the screen to be scrolled in a direction in which the first point was moved by the distance travelled by the first point.

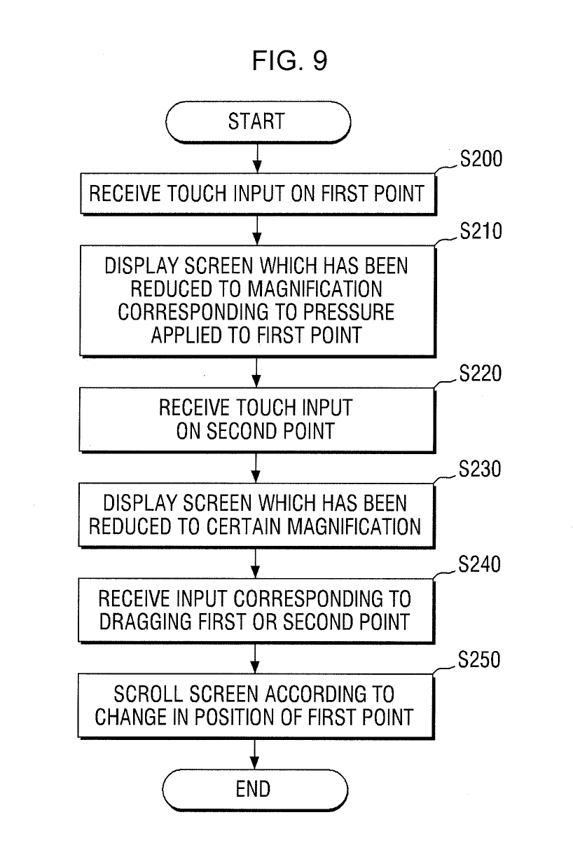

FIG. 9 is a flowchart illustrating a method of controlling the terminal 100 according to a second embodiment. Referring to FIG. 9, in the method of controlling the terminal 100 according to the second embodiment, a touch input on a first point on the touchscreen of the terminal 100 may be received (operation S200).

Then, a screen reduced to a magnification corresponding to the pressure applied to the first point may be displayed on the touchscreen (operation S210). The control unit 130 of the terminal 100 may control the screen to be reduced to a smaller size as the magnitude of the pressure increases. Alternatively, the control unit 130 of the terminal 100 may control the screen to be reduced to a smaller size as the magnitude of the pressure decreases. When the pressure applied to the first point is changed, the magnification of the reduced screen may also be changed.

Next, a touch input on a second point on the touchscreen may be received (operation S220).

Then, the screen reduced to a certain magnification regardless of a change in the pressure applied to the first point and a change in the pressure applied to the second point after the touch input on the second point was received may be displayed on the touchscreen (operation S230).

The control unit 130 may control the screen to be reduced to a magnification corresponding to the magnitude of the pressure applied to the first point when the second point started to be touched, regardless of the change in the pressure applied to the first point and the change in the pressure applied to the second point after the touch input on the second point was received. In other words, even if the pressure applied to the first point or the second point is changed after the touch input on the second point is received, the control unit 130 may control the magnification of the screen to be maintained at the magnification corresponding to the magnitude of the pressure applied to the first point when the second point started to be touched.

An input corresponding to dragging the first point or the second point may be received (operation S240).

Then, the reduced screen may be scrolled according to a change in the position of the first point, regardless of a change in the position of the second point, and may be displayed accordingly on the touchscreen (operation S250). The control unit 130 may control the screen to be scrolled according to the position of the first point, regardless of the position of the second point. The control unit 130 may control the screen to be scrolled in a direction in which the first point was moved by the distance travelled by the first point.

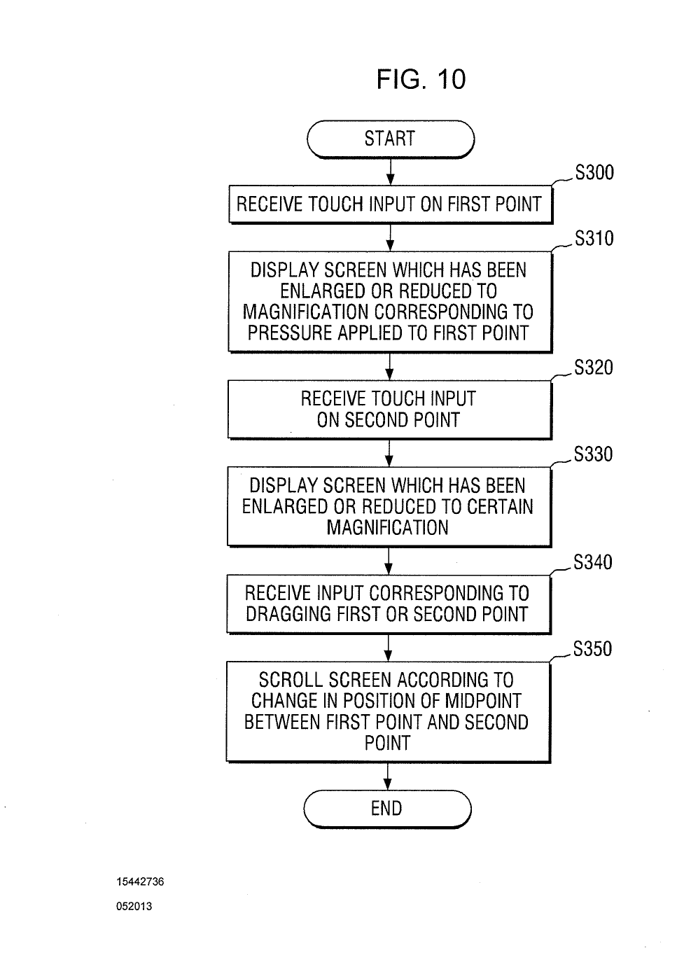

FIG. 10 is a flowchart illustrating a method of controlling the terminal 100 according to a third embodiment. Referring to FIG. 10, in the method of controlling the terminal 100 according to the third embodiment, a touch input on a first point on the touchscreen of the terminal 100 may be received (operation S300).

Then, a screen enlarged or reduced to a magnification corresponding to the pressure applied to the first point may be displayed on the touchscreen (operation S310). Next, a touch input on a second point on the touchscreen may be received (operation S320).

Then, the screen enlarged or reduced to a certain magnification regardless of a change in the pressure applied to the first point and a change in the pressure applied to the second point after the touch input on the second point was received may be displayed on the touchscreen (operation S330).

An input corresponding to dragging the first point or the second point may be received (operation S340).

Then, the enlarged or reduced screen may be scrolled according to a change in the position of a midpoint between the first point and the second point and may be displayed accordingly on the touchscreen (operation S350). The control unit 130 may control the screen to be scrolled according to the position of the midpoint between the first point and the second point. The control unit 130 may control the screen to be scrolled in a direction in which the midpoint between the first point and the second point was moved by the distance travelled by the midpoint.

According to at least one of the above embodiments, a screen displayed on a terminal can be enlarged, reduced or scrolled more easily. In addition, the screen displayed on the terminal can be enlarged, reduced or scrolled without selection of an icon or menu. Further, the screen displayed on the terminal can be enlarged, reduced or scrolled more rapidly.

While the above embodiments have been described with reference to the accompanying drawings, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A terminal comprising:
an input device configured to receive information from an external source;
a display configured to display an image; and
a controller configured to control the image displayed on the display according to the received information,
wherein the input device comprises a touchscreen, and wherein the controller is further configured to detect the number of touched points on the touchscreen, the magnitude of the pressure applied to each touched point and the position of each touched point based at least in part on the received information and control the image displayed on the display to be enlarged, reduced or scrolled based at least in part on the number, the magnitude and the position.

2. The terminal of claim 1, wherein when the number of touched points is one, the controller is further configured to control the image to be enlarged or reduced based at least in part on the position of the touched point, and when the position of the touched point is changed by dragging the touched point, the controller is further configured to control the image to be enlarged or reduced based at least in part on the changed position of the touched point.

3. The terminal of claim 1, wherein when the number of touched points is one, the controller is further configured to control the image to be enlarged or reduced according to the magnitude of the pressure applied to the touched point.

4. The terminal of claim 3, wherein the controller is further configured to control the image to be enlarged to a larger size or to be reduced to a smaller size as the magnitude increases.

5. The terminal of claim 3, wherein the controller is further configured to control the image to be enlarged to a larger size or to be reduced to a smaller size as the magnitude decreases.

6. The terminal of claim 1, wherein when the number of touched points is two, the controller is further configured to control the image to be enlarged or reduced to a magnification corresponding to the magnitude of the pressure applied to a first point, which was touched first, at a moment when a second point was touched and wherein the controller is further configured to control the magnification to be maintained despite a change in the magnitude of the pressure applied to the first point or a change in the magnitude of the pressure applied to the second point after the second point was touched.

7. The terminal of claim 6, wherein when the position of the first point or the position of the second point is changed by dragging the first point or the second point, the controller is further configured to control the image to be scrolled according to the changed position of the first point or the changed position of the second point.

8. The terminal of claim 7, wherein the controller is further configured to control the image to be scrolled according to a change in the position of the first point, regardless of a change in the position of the second point.

9. The terminal of claim 7, wherein coordinates of the first point before being dragged are (x1, y1), coordinates of the second point before being dragged are (x2, y2), the coordinates of the first point after being dragged are (x1′, y1′), the coordinates of the second point after being dragged are (x2′, y2′), and wherein the controller is further configured to control the image to be scrolled by (x1′−x1, y1′−y1).

10. The terminal of claim 7, wherein the controller is further configured to control the image to be scrolled in a state where the image has been enlarged or reduced to the magnification corresponding to the magnitude of the pressure applied to the first point at the moment when the second point was touched.

11. The terminal of claim 6, wherein when the position of the first point or the position of the second point is changed by dragging the first point or the second point, the controller is further configured to control the image to be scrolled according to a change in the position of a midpoint between the first point and the second point.

12. The terminal of claim 11, wherein the coordinates of the first point before being dragged are (x1, y1), the coordinates of the second point before being dragged are (x2, y2), the coordinates of the first point after being dragged are (x1′, y1′), the coordinates of the second point after being dragged are (x2′, y2′), and wherein the controller is further configured to control the image to be scrolled by ((x1′+x2′)/2−(x1+x2)/2, (y1′+y2′)/2−(y1+y2)/2).

13. A method of controlling a terminal having a touchscreen, the method comprising:
receiving a touch input on a first point on the touchscreen;
first displaying, on the touchscreen, an image which has been enlarged to a magnification corresponding to the pressure applied to the first point;
receiving a touch input on a second point on the touchscreen;
second displaying, on the touchscreen, the image which has been enlarged to a certain magnification regardless of a change in the pressure applied to the first point and a change in the pressure applied to the second point after the touch input on the second point was received;
receiving an input corresponding to dragging the first point or the second point; and
scrolling the enlarged screen according to a change in the position of the first point, regardless of a change in the position of the second point, and displaying the scrolled image on the touchscreen.

14. The method of claim 13, wherein the first displaying comprises displaying the image enlarged to a higher magnification on the touchscreen as the magnitude of the pressure applied to the first point increases.

15. The method of claim 13, wherein the first displaying comprises changing the magnification of the enlarged image when the pressure applied to the first point is changed.

16. The method of claim 13, wherein the second displaying comprises maintaining the magnification of the image at a magnification corresponding to the magnitude of the pressure applied to the first point at a moment when the second point was touched despite a change in the pressure applied to the first point or a change in the pressure applied to the second point after the touch input on the second point was received.

17. The method of claim 13, wherein the scrolling comprises controlling the image to be scrolled in a direction in which the first point was moved by the distance travelled by the first point.

18. A method of controlling a terminal having a touchscreen, the method comprising:
receiving a touch input on a first point on the touchscreen;
displaying, on the touchscreen, an image which has been reduced to a magnification corresponding to the pressure applied to the first point;
receiving a touch input on a second point on the touchscreen;
displaying, on the touchscreen, the image which has been reduced to a certain magnification regardless of a change in the pressure applied to the first point and a change in the pressure applied to the second point after the touch input on the second point was received;
receiving an input corresponding to dragging the first point or the second point; and
scrolling the reduced image according to a change in the position of the first point, regardless of a change in the position of the second point, and displaying the scrolled image on the touchscreen.

19. A method of controlling a terminal having a touchscreen, the method comprising:
receiving a touch input on a first point on the touchscreen;
displaying, on the touchscreen, an image which has been enlarged or reduced to a magnification corresponding to the pressure applied to the first point;
receiving a touch input on a second point on the touchscreen;
displaying, on the touchscreen, the image which has been enlarged or reduced to a certain magnification regardless of a change in the pressure applied to the first point and a change in the pressure applied to the second point after the touch input on the second point was received;
receiving an input corresponding to dragging the first point or the second point; and
scrolling the enlarged or reduced image according to a change in the position of a midpoint between the first point and the second point and displaying the scrolled image on the touchscreen.

20. The method of claim 19, wherein the scrolling and displaying comprises controlling the image to be scrolled in a direction in which the midpoint between the first point and the second point was moved by the distance travelled by the midpoint.
